(19) United States
(12) Patent Application Publication
(10) Pub. No.: US 2025/0362175 A1
(43) Pub. Date: Nov. 27, 2025

(54) SPECTRALLY-ENCODED NON-SCANNING IMAGING THROUGH FIBER

(71) Applicant: UNIVERSITY OF WASHINGTON, Seattle, WA (US)

(72) Inventors: Ningzhi Xie, Seattle, WA (US); Arka Majumdar, Seattle, WA (US); Quentin Tanguy, Seattle, WA (US); Johannes Emanuel Fröech, Seattle, WA (US); Karl F. Bohringer, Seattle, WA (US)

(73) Assignee: UNIVERSITY OF WASHINGTON, Seattle, WA (US)

(21) Appl. No.: 19/213,369

(22) Filed: May 20, 2025

Related U.S. Application Data
(60) Provisional application No. 63/650,443, filed on May 22, 2024.

(51) Int. Cl. G01J 3/28; G01J 3/02; G01J 3/44; H04N 23/12; H04N 23/50

(52) U.S. Cl. CPC G01J 3/2823; G01J 3/0218; G01J 3/2803; G01J 3/4406; H04N 23/12; H04N 23/555; G01J 2003/2809; G01J 2003/2826

(57) ABSTRACT

Systems and methods for spectrally-encoded non-scanning imaging through fiber are described. In one embodiment, a method for acquiring an endoscopic image includes: generating incoming light by a source of light; and directing the incoming light toward a metasurface filter array. The metasurface filter array includes a plurality of pixels, wherein each pixel includes a plurality of meta-atoms of a characteristic size. Characteristic sizes of the pluralities of meta-atoms differ from one pixel to another. The characteristic size of the meta-atoms of a given pixel is configured for a wavelength-specific band-pass transmission of light through the given pixel of the metasurface filter array. The method also includes transmitting spatio-spectrally encoded light through an optical fiber; decoding light transmitted through the optical fiber by a spectral decoder; and reconstructing the endoscopic image based on decoded light.

### CROSS-REFERENCE TO RELATED APPLICATION

This application claims the benefit of U.S. Provisional Application No. 63/650,443, filed May 22, 2024, the entire disclosures of which are hereby incorporated by reference.

### STATEMENT OF GOVERNMENT LICENSE RIGHTS

This invention was made with government support under Grant No. NSF GCR 2120774, awarded by the National Science Foundation. The government has certain rights in the invention.

### BACKGROUND

With the advent of neuroimaging and microsurgery, there is a rising need for capturing images of biological tissue, either before, during, or after surgery. Such imaging is constrained by the conflicting requirements of improved resolution, generally requiring larger imaging sensors, and insertion of the camera into a body (human or animal), generally requiring smaller imaging sensors. Accordingly, systems and methods for improved resolution and reduced size of the surgical imaging devices are still needed.

### SUMMARY

This summary is provided to introduce a selection of concepts in a simplified form that are further described below in the Detailed Description. This summary is not intended to identify key features of the claimed subject matter.

Recent advancements in neuroimaging and microsurgery have sparked an increasing demand for capturing images with miniaturized optical probes such as optical fibers. Briefly, the inventive technology is directed to imaging systems and methods that rely on a single fiber without mechanical scanning. The inventive technology implements spatial-spectral encoding of the acquired image, which is then transmitted outside of the body through the fiber being inserted in the body. In some embodiments, a metasurface filter array is configured at the distal end of the fiber (e.g., inside the body) to encode spatial information into a highly orthogonal spectrum. The metasurface filter array is optically coupled to the fiber at its distal end. At the proximal end of the fiber, the image of the object can be computationally recovered via the pseudo inverse process of the original spatio-spectral encoding process.

Metasurfaces, quasi-periodic structures with sub-wavelength thickness and periodicity, can realize spatial and spectral modulation of light. This spatio-spectral modulation of light operates to spectrally encode the incoming light (i.e., wavelength filter the incoming light) by an array of spatially arranged wavelength filters. For example, each wavelength filter of the metasurface filter array may include a group of nanostructures of a same size, where the size of the nanostructure determines a wavelength or a narrow range of wavelengths that is transmitted as a spectral information through the fiber. A group of wavelength-filtering nanostructures of the same size is referred to as a metasurface subsection, a subsection, or a pixel in the context of this specification. The spatial location of each such group of nanostructures provides the required spatial information of the spatio-spectral modulation of light.

Stated differently, a two dimensional array of pixels, each including nanostructures having a size that correspond to a desired wavelength-passband of the light, can thus function as a two dimensional spectral filter array for spectrally encoded non-scanning single fiber imaging, featuring designable and highly orthogonal spectral codes. Locations of the pixels provide the spatial reference for the signal encoding. Once the incoming image is spatio-spectrally encoded, the signal can be sent through a single fiber without the typical problems associated with sending light signal through a common optical fiber like, for example, introducing noise into the signal by bending the fiber, needing the calibration, etc. Here, the broadband light incident at different angles or positions is mapped to different spectral information, which can be transmitted through a multi-mode fiber without distortion or with reduced distortion. The spectra of light can be measured by a spectrometer at the proximal end of the fiber, followed by computational decoding to recover the spatial distribution of the imaged object at the distal end, where broadband light, incident at different angles or positions, is mapped to different spectra. That is, through computation, the intensity distribution at the distal end can thus be reconstructed.

In some embodiments, the nanostructures of the metasurface filter array can be manufactured by lithographic processes that are used in semiconductor manufacturing. For example, the metasurface filter array can be fabricated in a scalable way by nanoimprint lithography. Such miniaturization may be important for applications like endoscopy, which requires placing such an optical system inside a living being.

In one embodiment, a method for acquiring an endoscopic image includes: generating incoming light by a source of light; and directing the incoming light toward a metasurface filter array. The metasurface filter array includes a plurality of pixels, where each pixel includes a plurality of meta-atoms of a characteristic size, where characteristic sizes of the pluralities of meta-atoms differ from one pixel to another, and where the characteristic size of meta-atoms of a given pixel is configured for a wavelength-specific band-pass transmission of light through the given pixel of the metasurface filter array. The method also includes: transmitting spatio-spectrally encoded light through an optical fiber; decoding light transmitted through the optical fiber by a spectral decoder; and reconstructing the endoscopic image based on decoded light.

In one embodiment, the source of light is configured for generating the incoming light in a visible spectrum.

In one embodiment, the optical fiber is the only optical fiber configured for transmitting spatio-spectrally encoded light.

In one embodiment, the metasurface filter array includes 16 pixels.

In one embodiment, the optical fiber is a first optical fiber, and the method further includes transmitting spatio-spectrally encoded light through a second optical fiber.

In one embodiment, each of the first fiber and the second fiber corresponds to 16 pixels of the metasurface filter array.

In one embodiment, a number of pixels of the metasurface filter array corresponds to a number of subsections of the metasurface filter array.

In one embodiment, the source of light is a fluorescent particle.

In another embodiment, the source of light is a tunable laser.

In yet another embodiment, the source of light is a tunable laser.

In one embodiment, the spectral decoder is a spectrometer or a spectrum analyzer.

In one embodiment, an apparatus for endoscopy imaging includes: an optical fiber configured for transmitting light; and a metasurface filter array configured for a spatio-spectral encoding of incoming light. The spatio-spectral encoding includes a plurality of pixels, where each a spatial-spectral encoding includes a plurality of meta-atoms of a characteristic size, where characteristic sizes of the pluralities of meta-atoms differ from one pixel to another, and where a given characteristic size of the meta-atoms is configured for a wavelength-specific band-pass transmission of light through the corresponding pixel of the metasurface filter array.

### DESCRIPTION OF THE DRAWINGS

The patent or application file contains at least one drawing/photograph executed in color. Copies of this patent or patent application publication with color drawing(s) will be provided by the Office upon request and payment of the necessary fee.

The foregoing aspects and many of the attendant advantages of this invention will become more readily appreciated as the same become better understood by reference to the following detailed description, when taken in conjunction with the accompanying drawings, wherein:

FIG. 1 is a scanning electron micrograph image of a meta-optics in accordance with an embodiment of the present technology;

FIGS. 2A-2C illustrate several views of meta-optic's nanoposts in accordance with embodiments of the present technology;

FIG. 3 is a partially schematic isometric view of a metasurface filter array according to embodiments of the present technology;

FIG. 4 illustrates details of a metasurface filter array according to embodiments of the present technology;

FIG. 5 illustrates a metasurface filter array operation in accordance with embodiments of the present technology;

FIG. 6 illustrates image capturing and image reconstruction processes in accordance with embodiments of the present technology;

FIG. 7 illustrates a measured transmission spectra of individual pixels of a spatial-spectral encoding device in accordance with embodiments of the present technology;

FIG. 8 is a graph showing measured and fitted spectra of an all-open pattern in accordance with embodiments of the present technology;

FIG. 9 shows measurement results for a microscope image, decoded grayscale patterns, and recovered binary patterns in accordance with embodiments of the present technology; and

FIG. 10 is a graph of error rates of the recovered binary patterns obtained in accordance with embodiments of the present technology.

### DETAILED DESCRIPTION

While illustrative embodiments have been illustrated and described, it will be appreciated that various changes can be made therein without departing from the spirit and scope of the invention.

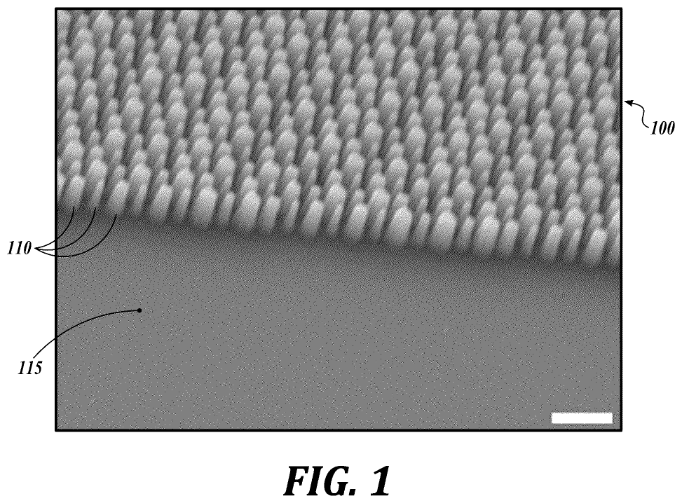

FIG. 1 is an optical image of a meta-optics (also referred as a metalens or meta-optic encoder) in accordance with an embodiment of the present technology. Illustrated meta-optics 100 includes a number of nanostructures (also referred to as nanoposts or scatterers) 110 that are carried by a substrate (also referred to as a carrier) 115. The nanostructures 110 may be nanoscale structures that are generally cylindrical or rectangular, and are characterized by one or more characteristic scales (e.g., cylinder diameter d, width w, height t, etc.). In some embodiments, the nanostructures 110 may have different sizes, as illustrated in FIG. 1. In different embodiments, the meta-optics 100 may be manufactured by the process described below.

In some embodiments, during the manufacturing of the meta-optics 100, a 600 nm layer of silicon nitride is first deposited via plasma-enhanced chemical vapor deposition (PECVD) on a quartz substrate, followed by spin-coating with a high-performance positive electron beam resist (e.g., ZEP-520A). An 8 nm Au/Pd charge dissipation layer is then sputtered followed by subsequent exposure to an electron-beam lithography system (e.g., JEOL JBX6300FS). The Au/Pd layer may then be removed with a thin film etchant (e.g., type TFA gold etchant), and the samples may be developed in amyl acetate. In some embodiments, to form an etch mask, 50 nm of aluminum is evaporated and lifted off via sonication in methylene chloride, acetone, and isopropyl alcohol. The samples are then dry etched using a CHF3 and SF6 chemistry and the aluminum is removed by immersion in AD-10 photoresist developer. In other embodiments, other manufacturing processes are possible.

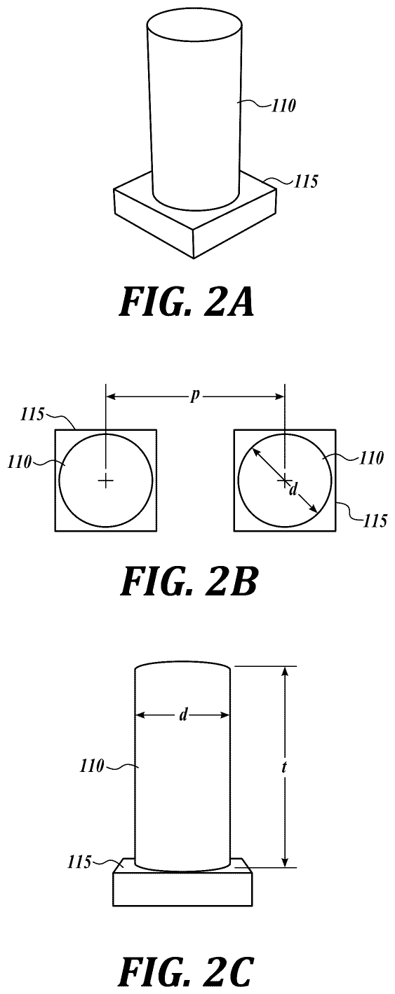

FIGS. 2A-2C illustrate several views of nanoposts in accordance with embodiments of the present technology. FIG. 2A is an isometric view of a nanopost (also referred to as meta-atoms) 110 that is carried by a substrate 115. The illustrated nanopost (meta-atom) 110 is cylindrical, but in other embodiments the nanopost 110 may have other shapes, for example, an elliptical cross-section, a square cross-section, a rectangular cross-section or other cross-sectional shape that maintain center-to-center spacing at a sub-wavelength value. FIG. 2B is a top view of two adjacent nanoposts that are separated by a distance “p” (pitch). Only two nanoposts are illustrated in FIG. 2B for simplicity. However, for a practical meta-optics 100, many more nanoposts are distributed over the substrate 115. FIG. 2C is a side view of a nanopost 110 that is carried by a substrate 115. In some embodiments, the nanoposts (scatterers, nanostructures) 110 are made of silicon nitride (SiN) due to its broad transparency window and CMOS compatibility.

The illustrated nanoposts 110 are characterized by a height “t” and diameter “d”. In some embodiments, the values of “d” may range from about 100 nm to about 300 nm. Generally, the value of “t” (height) is constant (within the limits of manufacturing tolerance) for all diameters “d” for a given metalens. In some embodiments, the values of “t” may range from about 500 nm to about 800 nm. The nanoposts (meta-atoms, scatterers) may be polarization-insensitive cylindrical nanoposts 110 arranged in a square lattice on a quartz substrate 115. The phase shift mechanism of these nanoposts arises from an ensemble of oscillating modes within the nanoposts that couple amongst themselves at the top and bottom interfaces of the post. By adjusting the diameter “d” of the nanoposts, the modal composition varies, modifying the transmission coefficient through the nanoposts.

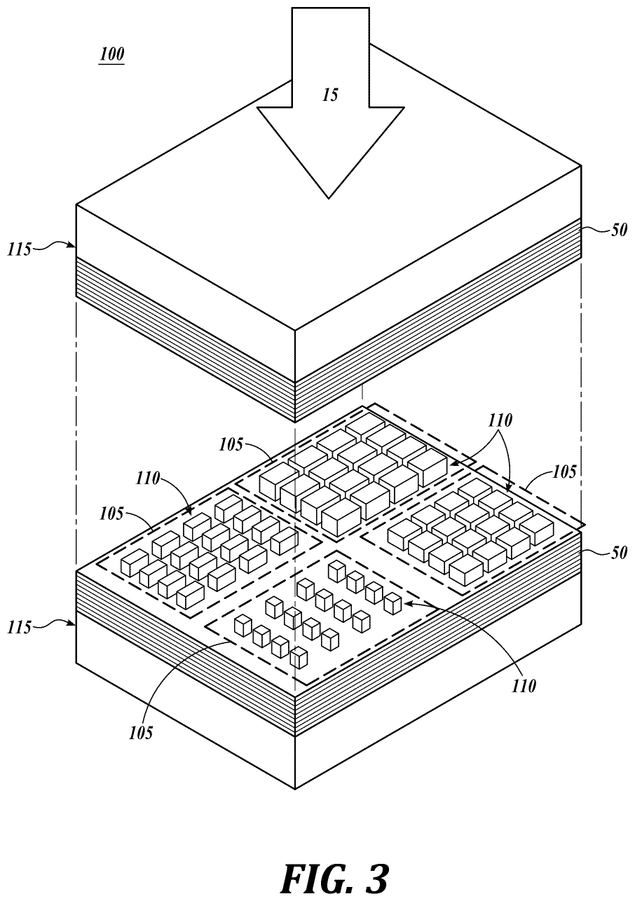

FIG. 3 is a partially schematic isometric view of a metasurface filter array 100 according to embodiments of the present technology. In some embodiments, the metasurface filter array 100 includes a plurality of pixels 105 (also referred to as subsections or metasurface subsections). In the illustrated embodiment, the metasurface filter array 100 includes a 2×2 array of pixels 105. Each pixel 105 includes a plurality of meta-atoms 110 (also referred to as “nanoposts” or “scatterers” or “nanostructures”). The meta-atoms 110 are sized to preferentially couple with a given wavelength of light, therefore each pixel 105 operates as a spectral encoder with a known spatial location. That is, each pixel 105 has a distinct wavelength passband, which can also be referred to as a spectral code. Furthermore, each pixel 105 has a fixed location with respect to other pixels 105. As a result, the incoming light 15 can be spatio-spectrally encoded by the metasurface filter array 100. In some embodiments, the meta-atoms 110 can be optically coupled with Bragg reflectors 50 and carried by semiconductor substrates 115, but other structures are also possible in different embodiments.

The metasurface filter array 100 may be manufactured by lithographic methods, thus making an insertion into a living body highly practical due to a relatively small size of both the metasurface filter array 100 and the fiber. In some embodiments, a material for meta-atoms 110 may be SiN for visible wavelength operation, because SiN has a low refractive index of about 2.

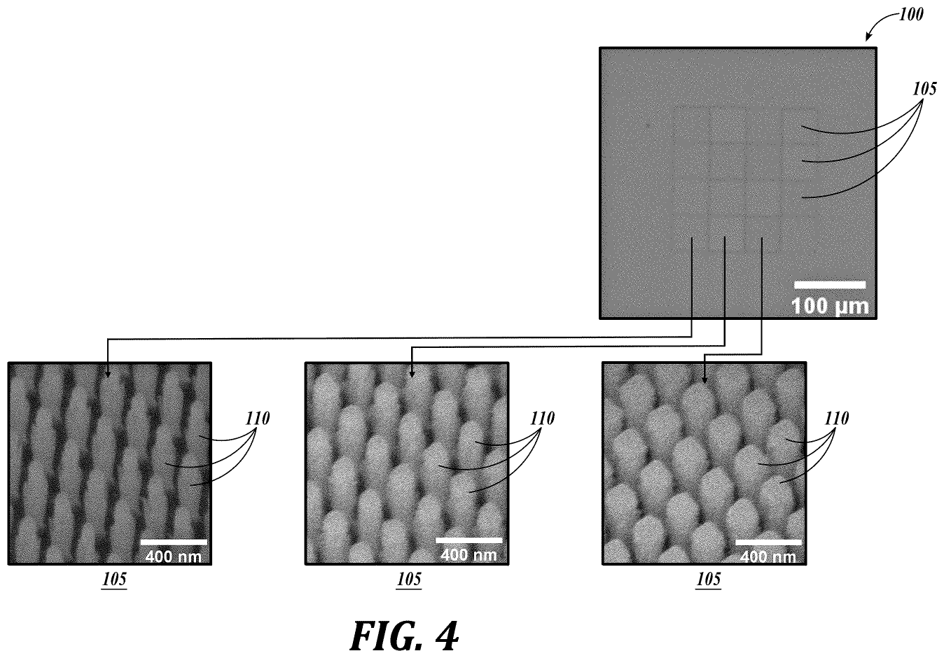

FIG. 4 illustrates details of a metasurface filter array according to embodiments of the present technology. These images were obtained by optical microscopy of a metasurface filter array 100 having a 4×4 array of pixels 105. Three pixels 105 are illustrated in the images of the lower row of images, in each case the meta-atoms 110 being imaged at an oblique angle of 40°. Each pixel 105 is characterized by a given dimension (e.g., diameter) of its meta-atoms 110.

In operations, different sizes of the meta-atoms 110 in different pixels 105 encode different wavelengths of light by imposing specific phase-shifts to the incoming light. For example, the three illustrated pixels 105 from left to right were designed to impose phase-shifts of ¼π, 2/4π, ¾π, respectively. Stated differently, the three illustrated pixels 105 produce different spectral encoding of the incoming light.

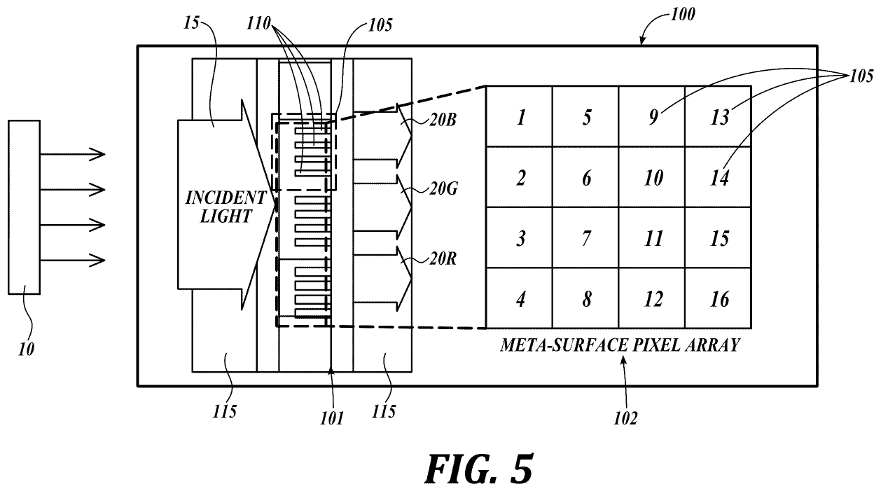

FIG. 5 illustrates a metasurface filter array operation in accordance with embodiments of the present technology. The illustrated metasurface filter array 100 has a 4×4 arrangement of the pixels 105 that collectively operate as a spectral filter array, with each pixel 105 preferentially encoding a distinct spectral and mutually orthogonal passband. For better conceptual clarity, the metasurface filter array 100 is presented in two views: a side view 101 and a top view 102. In operation, the incoming light 15 filters through the metasurface filter array 100 (shown as a side view 101) as a signal that is wavelength-location encoded as, for example, light signal 20B (blue), 20G (green), 20R (red), (and other 13 wavelengths, not specifically indicated), for the 16 pixels each having its location and the wavelength-passband preference. The 16 pixels 105 are best seen in the top view 102.

Ensuring orthogonality between the spectral codes is a relevant factor of the metasurface filter array. We engineer the phase delay of each pixelate metasurface (ϕᵢ) to effectively increase the round-trip phase delay of the cavity, ψ, by 2ϕᵢ, thus shifting the resonance wavelength λᵢ. To form a resonant mode in a cavity shown in FIG. 3, the round-trip phase ψ should satisfy:

$$ψ = 2 ( {ϕ}_{i} + \frac{2 π}{{λ}_{i}} L ) = 2 π q \qquad ( 1 )$$

where ϕᵢ is the phase shift imparted by each metasurface, λᵢ is the corresponding resonance wavelength of each spectral filter, L is the cavity length and q is an integer corresponding to the order of the resonance mode, assuming the light incident on the filter is a plane wave at normal incidence. In some embodiments, we set L=2.5, and use the resonance at q=9. The transmission peak wavelength for each filter can be written as:

$${λ}_{i} = \frac{2 L}{q - {ϕ}_{i} / π} = \frac{2 L}{q} + \frac{2 L}{{q}^{2}} \frac{{ϕ}_{i}}{π} + \frac{2 L}{( q - {ϕ}_{i} / π ) {q}^{2}} {( \frac{{ϕ}_{i}}{π} )}^{2} \qquad ( 2 )$$

The free spectral range (FSR) is given by the difference between two adjacent orders:

$$Δ {λ}_{FSR} = \frac{2 L}{q - 1} - \frac{2 L}{q} = \frac{2 L}{{q}^{2}} + \frac{2 L}{( q - 1 ) {q}^{2}} \qquad ( 3 )$$

showing that in order to cover the full FSR. The resonances λᵢ of the spectral filters should be confined within one FSR to avoid any overlap with resonances of different orders. Thus, from Eqns. 2 and 3, we conclude that the phase shifts metasurface phase delay ϕᵢ must range from 0 to π. With q>>1 and ϕᵢ∈(0, π), λᵢ can be approximated as

$$\frac{2 L}{q} + \frac{2 L}{{q}^{2}} \frac{{ϕ}_{i}}{π} = 555.6 + \frac{{ϕ}_{i}}{π} \cdot 61.7 ,$$

which is close to the design wavelength λ_{d}=560 and increases linearly with

$$\frac{{ϕ}_{i}}{π} . As \frac{{ϕ}_{i}}{π} ∈ ( 0 , 1 ) ,$$

the error term of this approximation,

$$\frac{2 L}{( q - {ϕ}_{i} / π ) {q}^{2}} {( \frac{{ϕ}_{i}}{π} )}^{2} ,$$

has an upper bound

$$\frac{2 L}{( q - 1 ) {q}^{2}} \frac{{ϕ}_{i}}{π} = \frac{{ϕ}_{i}}{π} \cdot 7.7 ,$$

which is 8 times smaller compared to the linear term. Therefore, this error term has negligible effect on the linearity of λᵢ as a function of ϕᵢ. As a result, to uniformly cover the FSR, ϕᵢ should range from 0 to π with equal intervals. We choose meta-atom with appropriate height, periodicity, and width to cover the 0-π phase range at this wavelength range.

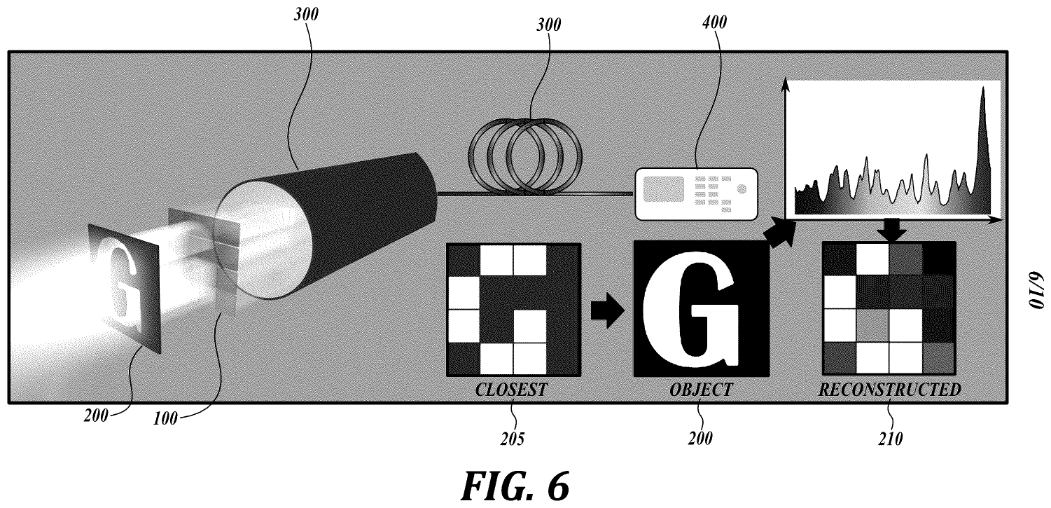

FIG. 6 illustrates image capturing and image reconstruction processes in accordance with embodiments of the present technology. In the illustrated embodiment, an object 200 is placed relatively close to the metasurface filter array 100. To emulate the object, a patterned chrome photomask was placed at the focal plane of a focused laser beam. To demonstrate the functionality of the metasurface filter array 100, the object 200 was replaced by a 4×4 pixel binary object 205 in front of the metasurface filter array 100. Each individual binary object may be a patterned chrome film, with each pixel of the 4×4 pixel binary object 205 either being transparent or blocking light, whereas each pixel of the binary object 205 has the same lateral dimensions of the pixel 105 of the metasurface filter array 100. In some embodiments, light from a tunable laser beam (or other source of light, e.g., a light emitting diode, a fluorescent particle, etc.) was directed onto the binary object (binary mask) 205, whereas only transparent portions appear bright. The width of the beam in the focal plane should be large enough to cover the full pattern. In this test operation, the light from the binary object 205 passes through the metasurface filter array 100, which encodes each spatial pixel of the binary object 205 into a unique spectral code by the operation of the corresponding wavelength passband properties of the pixels 105 of the metasurface filter array 100. Next, the spectrally encoded light is coupled into an optical fiber 300 that is connected to a spectral decoder 400 (e.g., spectrometer, spectrum analyzer, etc.) for measuring the transmitted spectrum. In many embodiments, a single fiber 300 can be used to transmit the signals from the metasurface filter array 100. However, due to relatively small diameter of the fiber 300, in some embodiments multiple fibers 300 of a fiber bundle can also be used. As light from the object 200 passes through the metasurface filter array 100, spatial pixel information is encoded into a unique spectral code, that is, a spatio-spectral encoding is obtained. Such spatio-spectral encoding is illustrated by the color graph insert in the upper right corner of FIG. 6.

The spectrally encoded light can be decoded by the spectral decoder 400 as a reconstructed object 210. In some embodiments, the spectral decoder 400 computationally decodes the spatio-spectral signals corresponding to the object 205 using a pseudo inverse of the matrix M containing the superposed spectral codes, therefore recovering the pattern of the object 205. To minimize the cross-coupling between the spectral codes, the columns of the matrix M should be as orthogonal as possible.

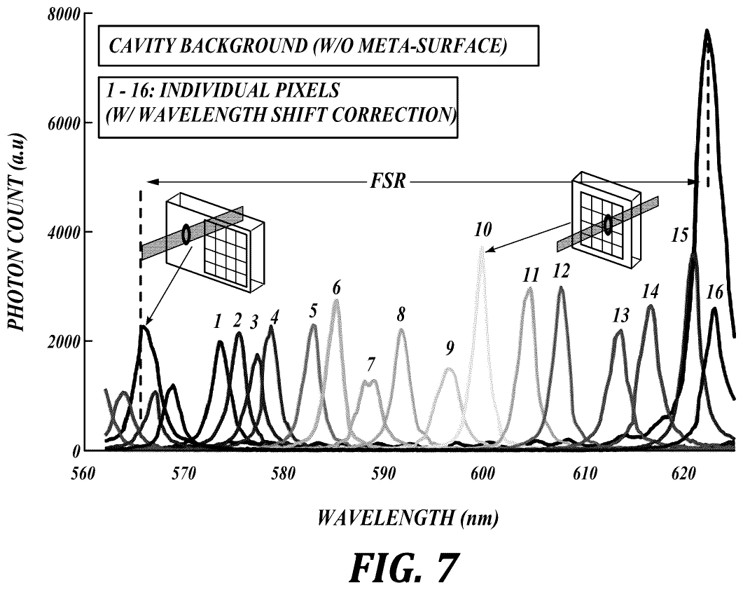

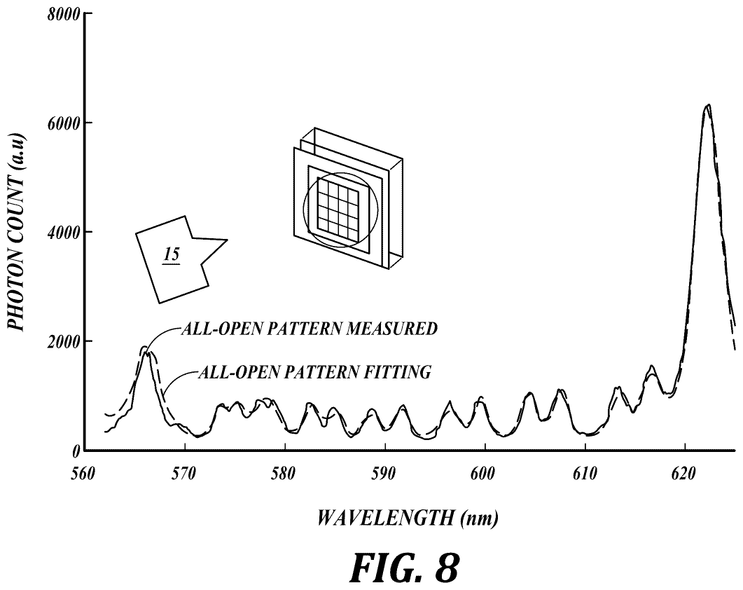

FIG. 7 illustrates a measured transmission spectra of individual pixels 105 of a spatial-spectral encoding device (metasurface filter array) 100 in accordance with embodiments of the present technology. FIG. 8 is a graph showing measured and fitted spectra of an all-open pattern in accordance with embodiments of the present technology. In both figures, the horizontal axis shows the wavelength of the light that is preferentially passed-through by either individual pixels 105 or an all-open pattern (without the pixels 105 of the metasurface filter array). The vertical axis shows a photon count, which may be understood, at least at the first level of approximation, as an intensity of light in each wavelength band.

The spectral graphs of FIG. 7 are shifted to align to the corresponding resonance peaks of the transmission spectrum of the all-open pattern. The transmission spectrum of an optical cavity without the metasurface filter array (i.e., the spectrum of the background light) is plotted in black for comparison. The spectral graphs of FIG. 8 show the measured and fitting spectra of the all-open pattern. The fitting spectrum is the weight summation of the spectra codes. In some embodiments, the decoding of the spectral information of, for example FIG. 7, can be accomplished as follows.

The spatio-spectral encoding process can be described as b=Ma, where a represents the m×1 vector of the input pixel values of a pattern, and b the n×1 spectral output. M is the spectral encoding transfer matrix. Each column of M is the spectral code of one corresponding spatial pixel. Decoding consists in retrieving the input pattern a, which can be achieved by pseudo inverse of M: a=M^{†}b, where M^{†} is the pseudo-inverse of matrix M. The details of the decoding algorithm can be found in the supporting information.

To retrieve the spatial input, M needs to be characterized prior to imaging. For example, the transmission spectra of all 16 single pixels 105 of the sample metasurface filter array 100 can be measured, therefore defining the spectral codes. Additionally, we can measure the background light, which is the transmission spectrum of the cavity when no metasurface is present (as shown, for example, in FIG. 8). In some embodiments, we may chose the wavelength range 560-625 for computational decoding, as this range is about one free spectral range (FSR) at the wavelength of 560 for a sample Fabry-Pérot (FP) cavity that has a cavity length of 2.5.

As can be seen in FIG. 7, the peaks of the spectral codes are well separated with minimal overlap, indicating high orthogonality of the spectral codes. The peak of the last two pixels overlap with the background as the metasurface phase shift of these two pixels is close to π. The effect of this overlap can be mitigated by including the background in the fitting in the decoding process. We note that the intensity peaks corresponding to the last two pixels overlap with the signal of the bare cavity, as the metasurface phase shift of these two pixels is close to π. However, the effect of this overlap can be corrected by including it as a background signal in the decoding process.

It should be noted that the measured spectral codes may undergo wavelength shift and amplitude modulation when compared to the spectrum of an all-open pattern, where all pixel intensities are defined as 1. We note that the measured spectral codes are slightly shifted and modulated in their amplitude as compared to the spectrum of the all-open pattern. Therefore, the transfer matrix M may be further calibrated by fitting the measured spectrum of the all-open pattern using the measured spectral codes and background. This will result in shifting the measured spectral codes in wavelength to align to the resonance peaks of the spectrum of the all-open pattern, and add weight factors to modulate the relative amplitude of the spectral codes. The fitted spectrum of the all-open pattern matches well with the measured spectrum (black solid line).

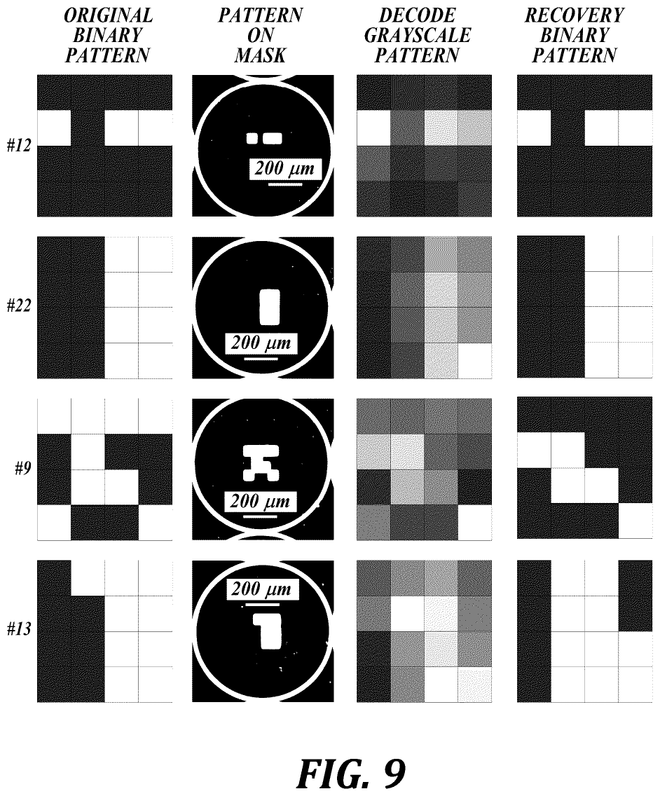

FIG. 9 shows measurement results for a microscope image, decoded grayscale patterns, and recovered binary patterns in accordance with embodiments of the present technology. Individual rows show different test images out of a variety of available images. In particular, what is illustrated are the 12th, 22nd, 9th, and 13th original binary patterns out of 24 tested patterns. The vertical columns correspond to the original binary patterns, the microscope image of the corresponding binary patterns on the chrome mask, the decoded grayscale patterns, and the recovered binary pattern from the decoded grayscale patterns. The threshold for determining whether the recovered binary pattern is 0 or 1 is set at the midpoint of the minimal and maximal greyscale values, however other thresholds may be used in different embodiments.

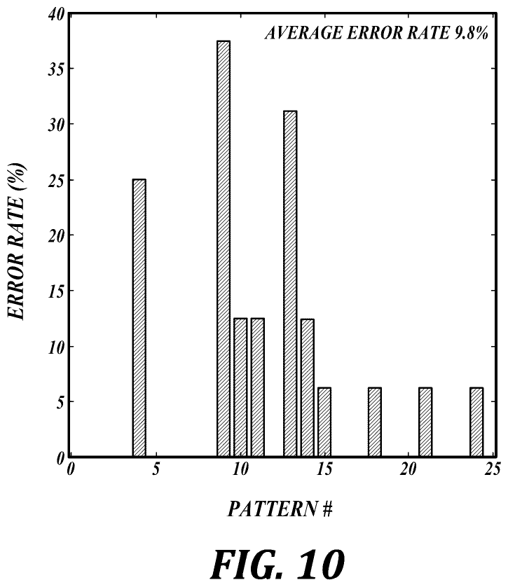

Using the calibrated transfer matrix M and the decoding method described above, we can recover the binary patterns from the measured spectra of these patterns and compare them with the original patterns. The first two patterns are recovered without error, while the last two patterns are the most erroneous among all measured patterns, as explained in more details below with respect to FIG. 10.

FIG. 10 is a graph of error rates of the recovered binary patterns obtained in accordance with embodiments of the present technology. The horizontal axis shows the number of the test pattern. Four test patterns are illustrated out of the 24 tested patterns. The vertical axis shows error rate as a percentage. To quantitatively evaluate the fidelity of the imaging approach, the error rate is defined as the number of pixels that are incorrectly reconstructed divided by the total number of pixels. For the experiment, we use a high resolution (0.2 nm) spectrometer with n=316 data points in the wavelength range of 562-625 nm (20 spectral data points per spatial pixel). An average error rate is determined as 9.8%.

While most patterns are accurately reconstructed (i.e., having one or less incorrect pixel assignment), some patterns (particularly, 9^{th} and 13^{th}) yield relatively high error rates, which may be mostly attributed to the about 10% average error rate of the spatial-spectral decoding experiment. This high error rate may stem from lateral misalignment between pixels of the binary patterns and the SSE device. For example, for the 13^{th} pattern, we observe that the recovered pattern yields a similar shape as the original pattern, but translated to the left by one pixel, indicating misalignment between pattern and the SSE device during the measurement. The high error rate of the 9^{th} pattern could be caused by another challenge—a divergence of light emitted from the light transmitted through the pattern. In particular, operation of the test metasurface filter array is based on the assumption that the incident light is a plane wave. This assumption is satisfied at the near-field imaging condition, where the Fresnel number, F=a²/λL>>1. However, in the experiment setup, the characteristic length for a single pixel of the pattern is half the size of the pixel, a=25, the propagation distance L≈600 (slightly thicker than the substrate 500), and the wavelength λ≈560. These parameters result in a Fresnel number F≈1.8, which leads to the divergence of the light. Consequently, the light from one single pixel of the pattern on the mask could leak to the surrounding pixels on the SSE device. The misalignment between the mask and the SSE device and the leaking of the light to the surrounding pixels may result in especially high error rates in some of the patterns. In particular, the 9^{th} pattern has a long contour length so that the leaking of the light to the surrounding pixel results in more erroneous pixel in the recovery pattern. The non-ideal plane wave incident of the light can cause deformations of the resonance transmission peaks of the cavity (the spectral codes of the metasurface filter array), which may also result in decoding errors. Nevertheless, an average error rate of 9.8% may be consider an acceptable results for the images of relatively complex objects obtained with a lithography-scale metasurface filter array coupled to a single fiber.

It is to be understood that the presently disclosed and/or claimed inventive concept(s) is not limited in its application to the details of construction and the arrangement of the components or steps or methodologies set forth in the following description. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

In the context of this disclosure, the terms “about,” “approximately,” “generally” and similar mean +/−5% of the stated value.

What is claimed is:

1. A method for acquiring an endoscopic image, the method comprising:
generating incoming light by a source of light;
directing the incoming light toward a metasurface filter array, wherein the metasurface filter array comprises a plurality of pixels, wherein each pixel comprises a plurality of meta-atoms of a characteristic size, wherein characteristic sizes of the pluralities of meta-atoms differ from one pixel to another, and wherein the characteristic size of meta-atoms of a given pixel is configured for a wavelength-specific band-pass transmission of light through the given pixel of the metasurface filter array;
transmitting spatio-spectrally encoded light through an optical fiber;
decoding light transmitted through the optical fiber by a spectral decoder; and
reconstructing the endoscopic image based on decoded light.

2. The method of claim 1, wherein the source of light is configured for generating the incoming light in a visible spectrum.

3. The method of claim 1, wherein the optical fiber is the only optical fiber configured for transmitting spatio-spectrally encoded light.

4. The method of claim 3, wherein the metasurface filter array comprises 16 pixels.

5. The method of claim 1, wherein the optical fiber is a first optical fiber, the method further comprising:
transmitting spatio-spectrally encoded light through a second optical fiber.

6. The method of claim 5, wherein each of the first fiber and the second fiber corresponds to 16 pixels of the metasurface filter array.

7. The method of claim 1, wherein a number of pixels of the metasurface filter array corresponds to a number of subsections of the metasurface filter array.

8. The method of claim 1, wherein the source of light is a fluorescent particle.

9. The method of claim 1, wherein the source of light is a tunable laser.

10. The method of claim 1, wherein the source of light is a tunable laser.

11. The method of claim 1, wherein the spectral decoder is a spectrometer or a spectrum analyzer.

12. An apparatus for endoscopy imaging, comprising:
an optical fiber configured for transmitting light; and
a metasurface filter array configured for a spatio-spectral encoding of incoming light, wherein the spatio-spectral encoding comprises a plurality of pixels, wherein each a spatial-spectral encoding comprises a plurality of meta-atoms of a characteristic size, wherein characteristic sizes of the pluralities of meta-atoms differ from one pixel to another, and wherein a given characteristic size of the meta-atoms is configured for a wavelength-specific band-pass transmission of light through the corresponding pixel of the metasurface filter array.

13. The apparatus of claim 12, further comprising a spectral decoder configured for decoding light transmitted through the fiber.

14. The apparatus of claim 13, wherein the spectral decoder is a spectrometer or a spectrum analyzer.

15. The apparatus of claim 12, wherein the metasurface filter array is configured inside a body of a patient.

16. The apparatus of claim 12, further comprising a source of light.

17. The apparatus of claim 16, wherein the source of light is configured for generating incoming light in a visible spectrum.

18. The apparatus of claim 16, wherein the source of light is a fluorescent particle.

19. The apparatus of claim 16, wherein the source of light is a tunable laser.

20. The apparatus of claim 12, wherein the metasurface filter array comprises 16 pixels.

21. The apparatus of claim 12, wherein the fiber is a first fiber, the apparatus further comprising at least one additional fiber.

22. The apparatus of claim 12, wherein a number of pixels of the metasurface filter array corresponds to a number of subsections of the metasurface filter array.
